(19) United States
(12) Patent Application Publication
(10) Pub. No.: US 2026/0321067 A1
(43) Pub. Date: Oct. 15, 2026

(54) TELEMATICS MODULE AND SYSTEM

(71) Applicant: Re:Car Inc., Troy, MI (US)

(72) Inventors: Tomoyuki Ishiwata, Fountain Valley, CA (US); Drew Walker, West Newton, MA (US)

(21) Appl. No.: 19/643,390

(22) Filed: Apr. 9, 2026

Related U.S. Application Data
(60) Provisional application No. 63/793,197, filed on Apr. 23, 2025.
(60) Provisional application No. 63/786,873, filed on Apr. 10, 2025.

(51) Int. Cl. G07C 5/00; B60L 58/12; B60L 58/16; B60R 16/023; G06F 8/65; G07C 5/04

(52) U.S. Cl. CPC G07C 5/008; B60L 58/12; B60L 58/16; B60R 16/0231; G06F 8/65; G07C 5/04; G07C 2205/02

(57) ABSTRACT

A telematics system comprising a vehicle and a telematics module. The vehicle comprises a data port and the telematics module comprises a connector that mates with the data port. The data port is in signal communication with at least one vehicle system and the telematics module is adapted and configured to control the at least one vehicle system, read data from the at least one vehicle system, and/or push software and/or firmware updates to the at least one vehicle system.

### CROSS-REFERENCE TO RELATED APPLICATIONS

The present application claims benefit of U.S. Provisional Application Nos. 63/786,873, filed Apr. 10, 2025, and 63/793,197, filed Apr. 23, 2025, incorporated herein by reference in their entireties.

### FIELD

The present teachings relate generally to a telematics module for a vehicle and a system comprising the same.

### BACKGROUND

Remote vehicle connection (e.g., via a mobile device) is a feature available in some vehicles for controlling some vehicle operations, such as auto-starting, climate pre-conditioning, or the like. This functionality is enabled by on-board vehicle telematics provided by an original equipment manufacturer (OEM), which is typically hard-wired into the vehicle and hidden in the vehicle, such as behind the instrument panel. However, on-board telematics is a costly vehicle option from the factory, and downstream addition of telematics is similarly costly and generally requires professional services or at least specialized knowledge and tools.

Some modern vehicles are built with equipment that is not accessible without a subscription. In this regard, the subscription permits some vehicle functions that were not otherwise operational without the subscription. The challenge with this practice is inclusion of equipment in vehicle lines, even if an end-user never intends to use a subscription feature. Thus, the vehicle is more costly with all of the equipment that may or may not be used.

There is a need for a modular telematics solution for vehicles.

### SUMMARY

The present teachings describe a system which may address at least some of the challenges identified above.

The telematics system may comprise a vehicle comprising a data port and a telematics module comprising a connector that mates with the data port. The data port may be in signal communication with at least one vehicle system and the telematics module may be adapted and configured to control the at least one vehicle system, read data from the at least one vehicle system, and/or push software and/or firmware updates to the at least one vehicle system.

The telematics module may not hardwired into the vehicle, in a from-the-factory manner or a manner of splicing into a vehicle network (e.g., CAN bus).

The vehicle may be free of an on-board telematics module apart from the telematics module of the present teachings.

The data port may be in the form of OBD, OBD-II, USB (e.g., a USB-C port), or a modified port adapted and configured to a USB protocol (e.g., a magnetic coupling connector with 6 electrical connections including 4 connections for data transmission and 2 connections for power transmission).

The data port may be a USB-C port or a modified port adapted and configured to a USB protocol.

The system may further comprise a remote element, such as a mobile device (e.g., a smartphone, a tablet, a laptop computer, or a smart wearable (e.g., a smart watch)), adapted and configured to wirelessly communicate with the telematics module.

The telematics module may comprise a wireless communication module. The wireless communication module may be adapted and configured to communicate via a cellular network, a network operating under the IEEE 802.11 standards, a short-range network operating in the 2.402 GHz to 2.48 GHz frequency bands, a GPS network, or any combination thereof.

The system may further comprise a gateway module comprised by the vehicle. The gateway module may have a wired connection to the data port (e.g., directly or through a vehicle network).

The telematics module may include a pass-through data port providing for indirect signal communication of a secondary device with the data port, or a wired connection with the remote device.

The at least one vehicle system may be selected from: a Global Positioning System (GPS) transceiver; one or more sensors pertaining to: vehicle speed, wheel speed, vehicle acceleration, battery health (e.g., battery charge, battery temperature, etc.), motor health (e.g., stator temperature, oil pressure, oil temperature, etc.), tire pressure, vehicle proximity, cabin temperature, seat temperature, HVAC temperature, fan speed, vent door position, or any combination thereof; a security and/or alarm system; an ignition; power door locks; power window regulators; a battery thermal control system, conditioner; a climate control system; or any combination thereof.

The vehicle may be an electric vehicle. The vehicle may be a reconfigurable vehicle.

### BRIEF DESCRIPTIONS OF THE DRAWINGS

FIG. 1 is a schematic representation of a system according to the present teachings.

FIG. 2 is a perspective view of a telematics module according to the present teachings.

FIG. 3 is a perspective view of a vehicle according to the present teachings.

### DETAILED DESCRIPTION

### Introduction

The description herein pertains to automotive vehicles. Preferably, it pertains to a vehicle that can be reconfigured from a first vehicle configuration to a second vehicle configuration. The vehicle can be reconfigured back to the first vehicle configuration. In other words, the vehicle has a reversible configurable structure.

In the context of the present description, “reversibly configurable” refers to structure having ability to be reconfigured (e.g., converted or transformed) from a first configuration to a second configuration and back to the first configuration. In this regard, “reversibly configurable” includes an ability of a structure to be reconfigured without permanently altering the structure in a way that would inhibit the structure from being reconfigured back to a previous configuration. For example, the structure may be reversibly configured from and/or between the first vehicle configuration to a second vehicle configuration without using permanent fasteners like adhesives or welding. For example, the structure may be reversibly configured from and/or between a first vehicle configuration to a second vehicle configuration without the need for using destructive material removal techniques causing permanent deformation such as cutting, milling, grinding, etc.

However, in some configurations, if drilling other insignificant plastic deformation is required to reconfigure the vehicle from or between the first and second vehicle configuration, such drilling is minimal and in accordance with an instruction approved by the original equipment manufacturer so that it avoids compromising structural integrity of the frame, and/or does not interfere with design and/or performance specifications of the original equipment manufacturer. For example, “reversibly configurable” includes an ability of a structure to be reconfigured with only limited drilling of openings in a vehicle structure, such as to receive a fastener in the transformed configuration. However, such drilling of openings does not prevent the structure from being converted or transformed back into a previous configuration.

The conversion of the vehicle from and/or between a first configuration and a second configuration according to these teachings may be accomplished or achieved by using non-permanent mechanical connections (e.g., mechanical fasteners, mechanical interlocks, bolts, screws, weld nuts, clamps, and/or friction fits). In this way, the reconfiguration may not permanently alter any of the vehicle components such that the vehicle components could not be returned to the previous configuration.

Advantageously, by utilizing non-permanent mechanical connections to add, remove, or reposition vehicle components during the reconfiguration or conversion, end users without access to complicated tools, machinery, and/or fabricating techniques can reconfigured the vehicle. Instead, common tool such as sockets, ratchets, wrenches, screw drivers, and the like can be used to reconfigure the vehicle, without the need for complicated and expensive tools, machinery, and/or fabricating techniques, such as, for example grinders, cutters, welders, etc.

The conversion of the vehicle from the first configuration to the second configuration may be performed after the vehicle has been placed in service by the original equipment manufacturer (OEM) In other words, the OEM may manufacture and offer the vehicle for sale in the first vehicle configuration as original equipment. Then, if a user desires the second vehicle configuration, the user may obtain the rear enclosure assembly and reconfigure the vehicle structure from the original equipment into the second vehicle configuration according to these teachings. The user can also reconfigure the vehicle back to the first vehicle configuration at a later time due to the reversibly configurable nature of the vehicle according to these teachings.

In the context of the present description, “original equipment” includes automotive vehicles and their respective components in a state as assembled during the construction of the vehicles as new vehicles. In contrast, “aftermarket” equipment includes components made by the OEM or by another entity other than the OEM, which might be installed as replacements or enhancements after the car comes out of the OEM factory. Components of the present description may be provided as components of original equipment vehicle, and/or provided as aftermarket components for installation on an original equipment vehicle (optionally using at least some of the hardware provided in the original equipment vehicle).

In the context of the present description, one of the vehicle configurations (e.g., first vehicle configuration or second vehicle configuration) may be a truck or pickup truck configuration. In the context of the present description, the other vehicle configuration (e.g., first vehicle configuration or second vehicle configuration) may be a sport utility vehicle (SUV) configuration.

In the context of the present description, a “pickup truck” includes a vehicle that may be a light, medium-duty, or heavy-duty truck. The pickup truck configuration may include a vehicle having an enclosed cab, cockpit, or occupant compartment (for at least a driver and at least one other occupant) and an open cargo area, namely a bed, located in the rear portion of the vehicle and being operable for storing and/or transporting cargo. A pickup truck configuration may be a vehicle that does not include a C-pillar, e.g., does not include a C-pillar that defines part of a cab. A pickup truck configuration may be a vehicle that does not include a D-pillar. A pickup truck configuration may be a vehicle that has a removable bulk head panel and rear window or glass assembly that can be completely removed or separated from the vehicle. A pickup truck configuration does not include features of a minivan.

In the context of the present description, a “sport utility vehicle” includes a vehicle that may be a light, medium-duty or heavy-duty vehicle including an enclosed cab (for at least a driver and at least one and preferably a plurality of other occupants), a cargo area enclosed by an enclosure, and a space behind a driver seat for or providing additional passenger seating. Thus, a “sport utility vehicle” includes a vehicle that is configured to receive at least one rear seat, at least one seat belt, and at least one air bag (e.g., a side curtain airbag mounted in an upper part of the vehicle adjoining an edge portion of the vehicle roof). When the vehicle is converted into the SUV configuration, C- and D-pillars may be added.

The vehicle in accordance with the present teachings (e.g., pickup truck configuration; SUV configuration, or any other configuration) may include a suspension. The suspension may include a solid axle. The suspension may include a de Dion suspension or axle. The suspension may include coil springs. The coil springs may be located forward or rearward of the solid axle and not on the axle. he suspension may be free of any leaf springs. The suspension may include one or more end plates that are integrally formed with the solid axle. The suspension may include a half shaft that extends from the one or more motors through an opening in the end plate.

The vehicle may include a front wheel drive system, a rear wheel drive system, or a combination of front and rear wheel drive (e.g., all-wheel drive system). As part of the reconfiguration, the vehicle may be converted from a rear wheel drive system to a wrong wheel drive system and/or to an all-wheel drive system.

The vehicle disclosed herein may be powered by an electrified powertrain (e.g., it is free of an internal combustion engine). An electrified powertrain may comprise one or more batteries. The one or more batteries may be chargeable by plugging the vehicle into a charging station and/or with regenerative features while the vehicle is in operation. The vehicle may include one or more wheel corner assemblies that include regenerative braking systems. The vehicle may include a front-wheel drive powertrain, a rear-wheel drive powertrain, or an all-wheel drive powertrain. A factory model of the vehicle may include rear-wheel drive or front-wheel drive, and an end user may install an additional motor or powertrain in the vehicle to convert the vehicle into all-wheel drive. The vehicle may comprise one or more motors, hardware, and/or software that allows for a plug-and-play integration when the powertrain is added or converted from front-wheel drive to rear-wheel drive and/or all-wheel drive, or from rear-wheel drive to front-wheel drive and/or all-wheel drive.

### System

The present description pertains to a telematics system for a vehicle, preferably a reconfigurable vehicle. The vehicle may be an automotive vehicle. The telematics system may function to provide for external communications with and/or control of the vehicle.

The vehicle may be wirelessly connected to a remote element (e.g., a mobile device) described herein. Wireless, as referred to herein, may include, but is not limited to a network operating under the IEEE 802.11 standards (commonly referred to as Wi-Fi™), a cellular network (optionally, the telematics module may accept a SIM card), a short-range network (e.g., a network operating in the 2.402 GHz to 2.48 GHz frequency bands, commonly referred to as Bluetooth®), or a Global Positioning System (GPS) network. The telematics module of the present teachings may comprise hardware capable of communicating via one or any combination of the foregoing.

The remote element may be a mobile device (vehicle-to-device), a cloud-based platform (vehicle-to-cloud), infrastructure nodes (vehicle-to-infrastructure), one or more other vehicles (vehicle-to-vehicle), a FOB, the like, or any combination thereof. In short, the system of the present teachings may provide for vehicle-to-everything connectivity.

The system may comprise a mobile device. The mobile device may include a smart phone, a tablet, a computer, a laptop, a smart wearable (e.g., a smart watch), or any combination thereof. The mobile device may typically be owned by the vehicle owner so that information on the vehicle can be monitored and/or one or more vehicle functions may be controlled from the mobile device. The mobile device may comprise a wireless network module. The wireless network module may wirelessly communicate with the telematics module described herein.

The cloud-based-platform may be used for over-the-air updates of the vehicle. Communication with the cloud-based-platform may be established via any wireless network nodes. The wireless network nodes may include a mobile device, a wireless router, or the like.

The infrastructure nodes may communicate with the vehicle. Such communication may be undertaken for traffic light operation, crosswalk signaling operation, crossing barrier operation, autonomous vehicle operations, or the like.

The vehicle may communicate with telematics modules of other vehicles. The other vehicles may be in the general vicinity of the vehicle. The vehicle-to-vehicle communication may be undertaken for autonomous vehicle operations.

The system of the present teachings may be particularly advantageous for fleet vehicles, for location tracking, collision detection, or both.

The system may comprise a telematics module. The telematics module may function to collect data from vehicle components (e.g., accessories, electronic control units, and the like), facilitate wireless communication with a remote element, or both.

The telematics module may comprise a wireless communication module. The telematics module may communicate with one or more remote elements via the wireless communication module. The telematics module may function as a network hotspot.

The telematics module may comprise one or more memory storage mediums. The memory storage medium may be a non-transitory memory storage medium. The memory storage medium may be adapted and configured to store, at least temporarily, vehicle information, software updates, logs, settings, security information, user information, or any combination thereof.

The telematics module may facilitate software and/or firmware updates for vehicle accessories and/or ECUs. The software updates may be over-the-air updates. By way of one example, over-the-air updates may be pushed through a mobile device (e.g., a smart phone).

The telematics module may comprise an output device and optionally an input device. The output device may function to form a wired connection to a gateway module described herein. The output device may be in the form of a cord and a connector. The connector may be in the form of OBD, OBD-II, USB (e.g., USB-A, USB-B, USB-C, Mini-USB, Micro-USB, or USB-3), Lightning, or any other suitable connector. It is also envisioned that the connector may run any of the foregoing protocols, but may be physically modified. By way of one exemplary aspect, the connector may be a magnetic coupling connector with 6 electrical connections including 4 connections for data transmission and 2 connections for power transmission, adapted and configured to a USB protocol. An exemplary connector may include a RoPD® connector, commercially available from Rosenberger.

The telematics module may include a pass-through data port. In this way, the data port in the vehicle to which the telematics module connects may remain accessible for signal communication and/or power transfer to another device, which may also be referred to herein as a secondary device. It is also envisioned that a remote device (e.g., a mobile device) may have a wired connection to the telematics module via the pass-through data port. The pass-through data port may be in the form of OBD, OBD-II, USB (e.g., USB-A, USB-B, USB-C, Mini-USB, Micro-USB, or USB-3), Lightning, or any other suitable connector.

The telematics module may not be hardwired into the vehicle , in a from-the-factory manner or a manner of splicing into a vehicle network (e.g., CAN bus). The telematics module may connect to the vehicle with a male and female type connection.

The vehicle may be free of an on-board telematics module apart from the telematics module of the present teachings. The vehicle may be incapable of wirelessly communicating with one or more remote elements, at least without the telematics module of the present teachings. The vehicle may be free of a wireless communication module apart from the wireless communication module of the telematics module. In this regard, the telematics module of the present teachings may function as a modular component to provide telematics functionality that was not included in the vehicle by the OEM.

The vehicle may comprise one or more vehicle data ports. The data port may be in the form of USB (e.g., USB-A, USB-B, USB-C, Mini-USB, Micro-USB, or USB-3), Lightning, or any other suitable port. It is also envisioned that the port may run any of the foregoing protocols, but may be physically modified. By way of one exemplary aspect, the port may be a magnetic coupling port with 6 electrical connections including 4 connections for data transmission and 2 connections for power transmission, adapted and configured to a USB protocol. An exemplary port may include a port for a RoPD® connector, commercially available from Rosenberger.

The one or more data ports may be located on, in, or behind an instrument panel of the vehicle. The one or more data ports may be accessible to a driver without removal or other modification of the instrument panel. The one or more data ports may be hidden behind the instrument panel. The one or more data ports may be proximate to a steering column. The one or more data ports may be on-board a gateway module. The one or more data ports may be separate from a gateway module.

The vehicle may comprise a gateway module. The gateway module may be an ECU on-board the vehicle. The gateway module may be connected to the vehicle network (e.g., a CAN bus). The gateway module may signally communicate with the accessories and/or ECUs on the vehicle. In this regard, the gateway module may collect information from accessories and/or ECUs, push control signals to accessories and/or ECUs, push software and/or firmware updates to accessories and/or ECUs, or any combination thereof.

The telematics module, via the gateway module, may signally communicate with one or more accessories and/or ECUs, which may be referred to herein as vehicle systems. The accessories may include one or more controllers. The telematics module may signally communicate with any element on the vehicle network. It is envisioned that the telematics module and/or gateway module may signally communicate indirectly with a vehicle system endpoint. By way of example, in the case of a parent controller and child controller relationship, the telematics module and/or gateway may signally communicate indirectly with a child controller having the parent controller as an intermediary.

The telematics module may signally communicate with a Global Positioning System (GPS) transceiver; one or more sensors pertaining to: vehicle speed, vehicle acceleration, battery health (e.g., battery charge, battery temperature, etc.), motor health (e.g., stator temperature, oil pressure, oil temperature, etc.), tire pressure, vehicle proximity, cabin temperature, seat temperature, HVAC temperature, fan speed, vent door position, any sensor capable of generating vehicle diagnostic codes, or any combination thereof; a security and/or alarm system; an ignition; power door locks; power window regulators; a battery thermal control system, conditioner; a climate control system; a sun shade; a sunroof; one or more proximity sensors, one or more cameras; one or more seat heaters; or any combination thereof.

Some exemplary, but non-limiting, functions of the telematics module may include: collision detection of fleet vehicles, location tracking of fleet vehicles, scheduled battery preconditioning, scheduled climate preconditioning, remote start, battery charge management (e.g., charge limit, charge times, charging routines), or any combination thereof.

The telematics module may be adapted and configured to only send commands while the vehicle is a parked state. Verifying that the vehicle is in park may be done via GPS, vehicle speed sensing, accelerometer sensing, or the like.

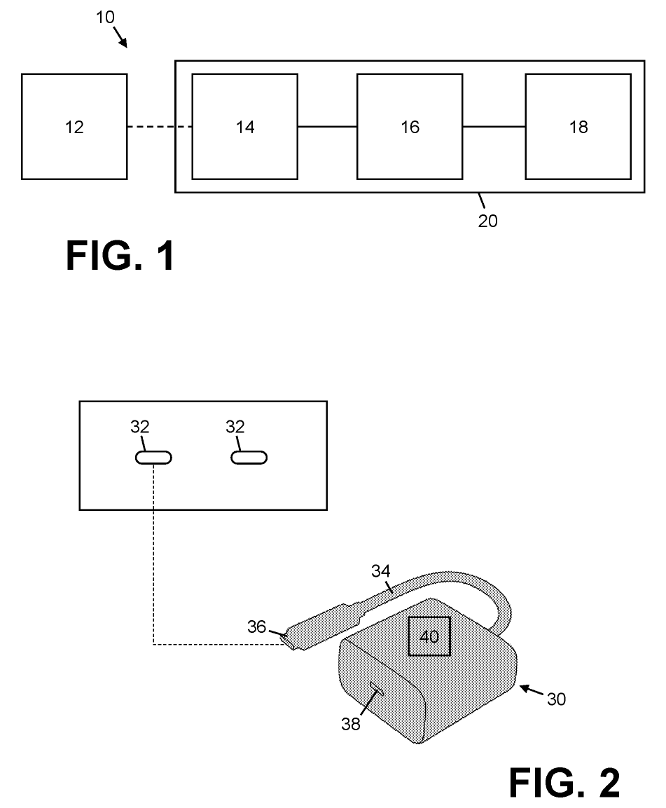

FIG. 1 illustrates a telematics system 10 according to the present teachings. The telematics system 10 comprises a mobile device 12, which wirelessly communicates with a telematics module 14 that has a removable wired connection to a data port 16 that provides for signal communication with a gateway module 18.

The telematics module 14 is not native to a vehicle 20 on which it is installed, as discussed herein. In this regard, the telematics module 14 includes a connector to connect to the data port 16.

FIG. 2 illustrates a telematics module 30 in relation to data ports 32 (e.g., a USB-C port), provided in duplicate, by which the telematics module 30 connects to a gateway module (not shown). The telematics module 30 includes a cable 34, terminating at a connector 36. and As shown, the connector 36 is a male connector, but the present teachings are not intended to be limited to this configuration. The telematics module 30 comprises a pass-through data port 38, as described herein. The pass-through data port 38 is shown as a female element, but the present teachings are not intended to be limited to this configuration. The telematics module 30 comprises a wireless communication module 40 by which a mobile device or other element may signally communicate with the telematics module.

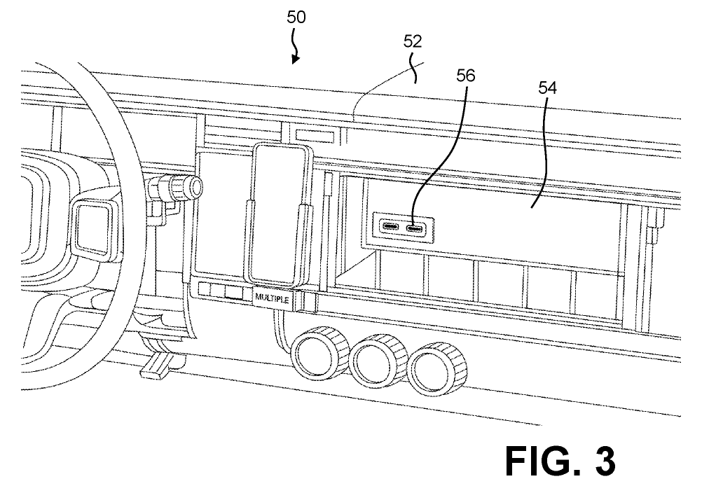

FIG. 3 illustrates an exemplary vehicle 50. The vehicle 50 comprises an instrument panel 52. The instrument panel 52 includes a compartment 54 that can be in an open format, or coverable by a door. A wall of the compartment 54 includes data ports 56.

The explanations and illustrations presented herein are intended to acquaint others skilled in the art with the invention, its principles, and its practical application. The above description is intended to be illustrative and not restrictive. Those skilled in the art may adapt and apply the invention in its numerous forms, as may be best suited to the requirements of a particular use.

Accordingly, the specific embodiments of the present invention as set forth are not intended as being exhaustive or limiting of the teachings. The scope of the teachings should, therefore, be determined not with reference to this description, but should instead be determined with reference to the appended claims, along with the full scope of equivalents to which such claims are entitled. The omission in the following claims of any aspect of subject matter that is disclosed herein is not a disclaimer of such subject matter, nor should it be regarded that the inventors did not consider such subject matter to be part of the disclosed inventive subject matter.

Plural elements or steps can be provided by a single integrated element or step. Alternatively, a single element or step might be divided into separate plural elements or steps.

The disclosure of "a" or "one" to describe an element or step is not intended to foreclose additional elements or steps. For example, disclosure of “a motor” does not limit the teachings to a single motor. Instead, for example, disclosure of “a motor” may include “one or more motors.”

While the terms first, second, third, etc., may be used herein to describe various elements, components, regions, layers and/or sections, these elements, components, regions, layers and/or sections should not be limited by these terms. These terms may be used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The invention illustratively disclosed herein suitably may be practiced in the absence of any element which is not specifically disclosed herein.

Any of the elements, components, regions, layers and/or sections disclosed herein are not necessarily limited to a single embodiment. Instead, any of the elements, components, regions, layers and/or sections disclosed herein may be substituted, combined, and/or modified with any of the elements, components, regions, layers and/or sections disclosed herein to form one or more embodiments that may not be specifically illustrated or described herein.

The disclosures of all articles and references, including patent applications and publications, testing specifications, are incorporated by reference for all purposes.

Other combinations are also possible as will be gleaned from the following claims, which are also hereby incorporated by reference into this written description.

Any numerical values recited in the above application include all values from the lower value to the upper value in increments of one unit provided that there is a separation of at least 2 units between any lower value and any higher value. These are only examples of what is specifically intended and all possible combinations of numerical values between the lowest value, and the highest value enumerated are to be considered to be expressly stated in this application in a similar manner. Unless otherwise stated, all ranges include both endpoints and all numbers between the endpoints.

The term “consisting essentially of” to describe a combination shall include the elements, ingredients, components, or steps identified, and such other elements ingredients, components or steps that do not materially affect the basic and novel characteristics of the combination. The use of the terms “comprising” or “including” to describe combinations of elements, ingredients, components, or steps herein also contemplates embodiments that consist essentially of the elements, ingredients, components, or steps.

### REFERENCE NUMERALS

10 telematics system
12 mobile device
14 telematics module
16 data port
18 gateway module
20 vehicle
30 telematics module
32 data ports
34 cable
36 connector
38 pass-through data port
40 wireless communication module
50 vehicle
52 instrument panel
54 compartment
56 data port
60 telematics module
62 data port
64 mounting point

What is claimed is:

1. A telematics system comprising: a vehicle comprising a data port and a telematics module comprising a connector that mates with the data port; and wherein the data port is in signal communication with at least one vehicle system and the telematics module is adapted and configured to control the at least one vehicle system, read data from the at least one vehicle system, and/or push software and/or firmware updates to the at least one vehicle system.

2. The telematics system according to claim 1, wherein the telematics module is not hardwired into the vehicle, in a from-the-factory manner or a manner of splicing into a vehicle network (e.g., CAN bus).

3. The telematics system according to claim 2, wherein the vehicle is free of an on-board telematics module apart from the telematics module.

4. The telematics system according to claim 3, wherein the data port is telematics in the form of OBD, OBD-II, USB (e.g., a USB-C port), or a modified port adapted and configured to a USB protocol.

5. The telematics system according to claim 4, wherein the data port is a USB-C port or a modified port adapted and configured to a USB protocol.

6. The telematics system according to claim 5, further comprising a remote element, such as a mobile device (e.g., a smartphone, a tablet, a laptop computer, or a smart wearable (e.g., a smart watch)), adapted and configured to wirelessly communicate with the telematics module.

7. The telematics system according to claim 6, wherein the telematics module comprises a wireless communication module; and wherein the wireless communication module is adapted and configured to communicate via a cellular network, a network operating under the IEEE 802.11 standards, a short-range network operating in the 2.402 GHz to 2.48 GHz frequency bands, or any combination thereof.

8. The telematics system according to claim 7, further comprising a gateway module comprised by the vehicle; and wherein the gateway module has a wired connection to the data port (e.g., directly or through a vehicle network, such as a CAN bus).

9. The telematics system according to claim 8, wherein the telematics module includes a pass-through data port providing for indirect signal communication of a secondary device with the data port.

10. The telematics system according to claim 9, wherein the at least one vehicle system is selected from: a Global Positioning System (GPS) transceiver; one or more sensors pertaining to: vehicle speed, wheel speed, vehicle acceleration, battery health (e.g., battery charge, battery temperature, etc.), motor health (e.g., stator temperature, oil pressure, oil temperature, etc.), tire pressure, vehicle proximity, cabin temperature, seat temperature, HVAC temperature, fan speed, vent door position, or any combination thereof; a security and/or alarm system; an ignition; power door locks; power window regulators; a battery thermal control system, conditioner; a climate control system; or any combination thereof.

11. The telematics system according to claim 10, wherein the vehicle is an electric vehicle.

12. The telematics system according to claim 11, wherein the vehicle is a reconfigurable vehicle.
